(19) United States
(12) Patent Application Publication
(10) Pub. No.: US 2024/0376771 A1
(43) Pub. Date: Nov. 14, 2024

(54) ROLLING SHUTTER SYSTEM AND COMPONENT PARTS

(71) Applicant: EASTERN METAL SUPPLY INC., Lake Worth, FL (US)

(72) Inventors: Greg WEEKES, Lake Worth, FL (US); Raffaele BARIOLI, Lake Worth, FL (US); Bill FEELEY, Lake Worth, FL (US); Brian PETERSON, Lake Worth, FL (US)

(73) Assignee: EASTERN METAL SUPPLY INC., Lake Worth, FL (US)

(21) Appl. No.: 18/782,132

(22) Filed: Jul. 24, 2024

Related U.S. Application Data
(63) Continuation of application No. 16/874,865, filed on May 15, 2020, now abandoned.
(60) Provisional application No. 62/875,734, filed on Jul. 18, 2019.

(51) Int. Cl. E06B 9/15; E06B 9/171; E06B 9/58

(52) U.S. Cl. CPC E06B 9/15; E06B 9/171; E06B 9/58; E06B 2009/1505; E06B 2009/1544

(57) ABSTRACT

A main slat for a roller shutter system is provided. The slat includes a slat body having a first and second end, a hook end connected to the first end of the slat body, a screw boss connected to the second end of the slat body, and a receiving end connected to the screw boss. The hook end and the receiving end are each shaped such that the hook end is laterally insertable into the receiving end of an adjacent main slat and when so inserted forms a hinge. The slat body has a central cross section including at least first and second portions, the first and second portions each having a different radius of curvature.

### CROSS REFERENCE TO RELATED APPLICATIONS

The instant application is a Continuation application of U.S. application Ser. No. 16/874,865 entitled ROLLING SHUTTER SYSTEM AND COMPONENT PARTS filed May 15, 2020, which claims priority to U.S. Provisional Application 62/875,734 entitled ROLLING SHUTTER SYSTEM AND COMPONENT PARTS filed Jul. 18, 2019, the contents of which are incorporated by reference in their entirety.

### FIELD OF THE INVENTION

The instant application relates to a rolling shutter system. More specifically, the instant application relates to a rolling shutter system with improved structural integrity.

### BACKGROUND

Rolling storm and security shutters are well known in the art. Such shutters cover windows, doors and other portal openings for protection against elements or intruders. Systems typically comprise a shutter assembly of interlocking slats disposed between a pair of guide tracks attached to opposite sides of the portal opening with a top most slat connected to a reel tube. The slats could be wound around the reel tube into a retracted/open state when the portal is to be open, and thus unwound so the slats freely slide along the guide tracks to a deployed/closed position when the portal is closed. In the closed position, the guide tracks further serve to hold the shutter assembly in place to reduce unwanted lateral movement due to displacement forces applied by burglars or the elements. There are a variety of considerations that influence the design of the slats, including strength of the slat, amount of material (typically aluminum or plastic) to make the slat, and compactness of the winding around the reel tube.

Referring now to FIG. 1, two interconnected prior art slats 100 of U.S. Pat. No. 9,309,715 are shown. The slat has a hook end 102, a receiving end 104, a screw boss 106, and a body 108 between the hook end 102 and receiving end 104; multiple adjacent slats 100 interlock at adjacent hook and receiving ends 102 and 104 to link together to form a curtain. The body 108 has a uniform radius of curvature over its entire length, and the hook end 102 has an outwardly extending bend 110 to transition the hook end 102 into a position in which it can engage a receiving end 104 of an adjacent slat 100. The screw boss 106 is partially open at 112 to the external environment along its length; this provides mechanical tolerance for insertion of screws to fit into guide rails, although the open nature also provides a path for water and debris to enter.

### BRIEF DESCRIPTION OF THE DRAWINGS

Various embodiments in accordance with the present disclosure will be described with reference to the drawings, in which:

FIG. 1 is an end to end cross section of interconnected slats of a prior art rolling shutter system.

FIGS. 2A and 2B show an embodiment of a rolling shutter system in a retracted and deployed state, respectively.

FIG. 3 is an end to end cross section along a central axis of a main slat according to an embodiment of the invention.

FIG. 4 is a perspective view of the main slat of FIG. 3.

FIG. 5 shows the screw boss of the main slat of FIG. 3.

FIGS. 6A and 6B show adjacent connected main slats of FIG. 3.

FIGS. 7A and 7B show an embodiment of a reel tube.

FIGS. 8A and 8B show an embodiment of a starter slat.

FIGS. 9A and 9B show a relationship between a starter slat and a reel tube according to an embodiment of the invention.

FIG. 10 shows an embodiment of drive components of an embodiment of the invention.

FIGS. 11 and 12 show possible relationships between main slats and guide rails according to embodiments of the invention.

FIG. 13 shows a rolling shutter system installed over a portal and in a partially deployed state.

FIGS. 14A, 14B and 15 show possible drivers for driving rotation of the shutter system according to embodiments of the invention.

FIGS. 16 and 17 show possible shapes of the screw boss of a shutter system according to embodiments of the invention.

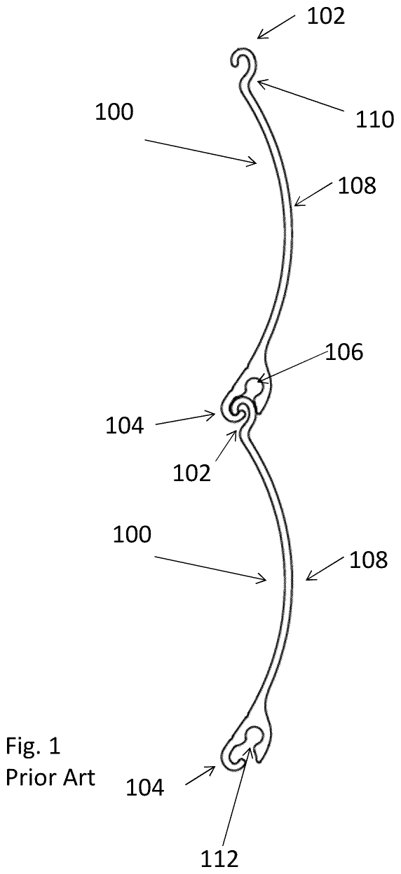

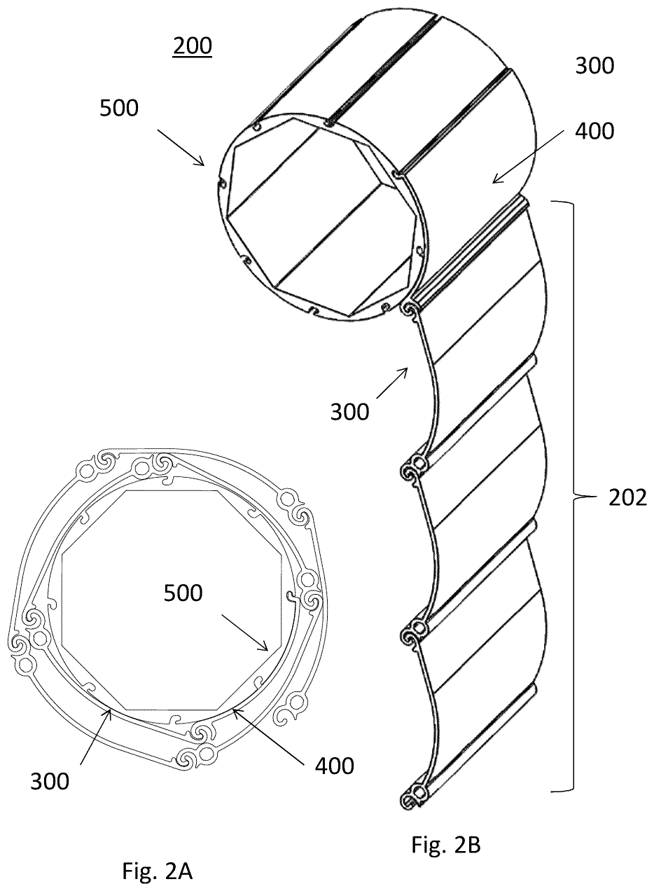

FIGS. 2-9 are to scale in end to end section and perspective for a length as shown, although actual components are cut to length or prefabricated to length as desired.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. An individual skilled in the relevant art will recognize that other caps and configurations may be used without departing from the scope and spirit of the claimed subject matter.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. Substantially “parallel” “perpendicular” or the like are preferably within about 5-10 degrees of ideal. Distances or sizes referred to as “substantially the same” or the like are less than about ±5%, preferably less than about ±3%, particularly less than 0.01 inch variation, and most particularly identical to thousands of an inch scale.

The term “comprising” when utilized, means “including, but not necessarily limited to”; it specifically indicates open-ended inclusion or membership in the so-described combination, group, series and the like. The term “a” means “one or more” absent express indication that it is limited to the singular. “First,” “second,” etc. are labels to differentiate like terms from each other, and does not imply any order or numerical limitation.

A used herein “horizontal” “vertical,” “diagonal,” “top,” “bottom,” “upper,” “lower” and the like are to provide a frame of reference for portions of the embodiments to be described relative to each other, and not to absolute space. Thus for example a surface may be described as horizontal so another surface can be described and diagonal or vertical relative thereto. However, such frames of reference do not limit the scope of the invention, e.g., rotating cap to a different orientation does not change the special relationship.

Referring now to FIGS. 2A and 2B, a roller shutter system 200 includes several interconnected main slats 300, a starter slat 400, and a reel tube 500. As discussed in more detail below, adjacent main slats 300 connect together to form a curtain 202, and starter slat 400 acts as interface that connects an edge of curtain 202 to reel tube 500. To retract the curtain 202 and open the portal that it covers, reel tube 500 rolls in a direction (e.g., counterclockwise in FIG. 2A) to wind around reel tube 500 to reach a retracted state as shown in FIG. 2A. To deploy the curtain 202 and cover the portal, reel tube 500 rolls in the opposite direction to unwind curtain 202 around reel tube 500 to reach a deployed state as shown in FIG. 2B.

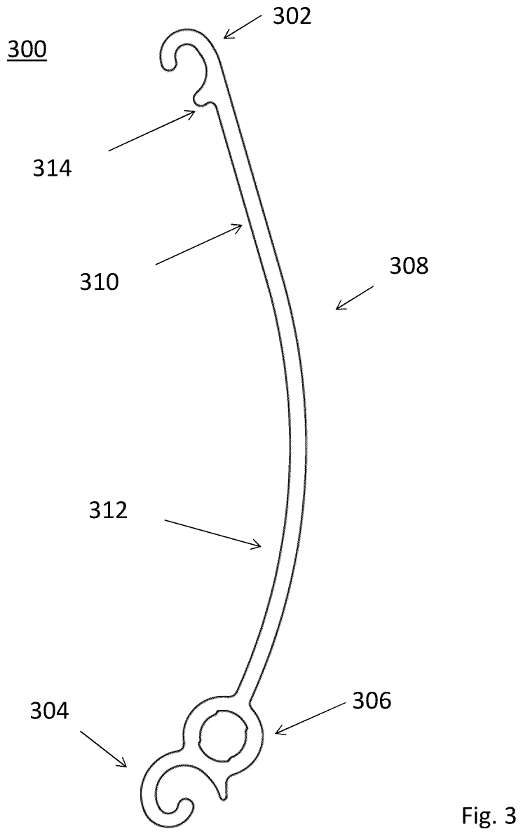

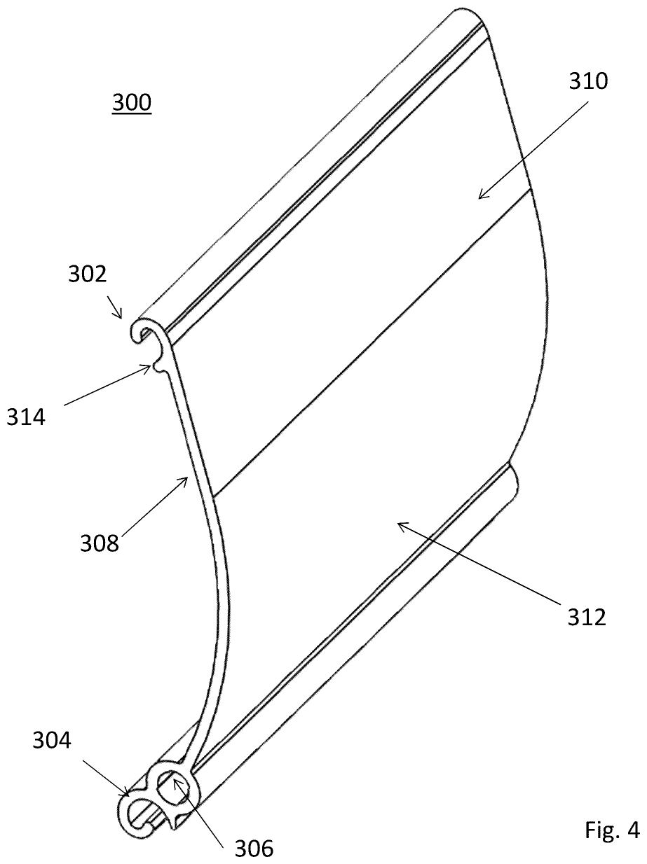

Referring now to FIGS. 3 and 4, main slat 300 has a hook end 302, a receiving end 304, a screw boss 306, a slat body 308 there between, and a nub 314 projecting inward at the top of slat body 308. The hook end 302, receiving end 304 and nub 314 are shaped so that a hook end 302 and receiving end 304 of adjacent main slats 300 one can laterally slide into engagement with each other to form a hinge as shown in FIGS. 2A and 2B, and will not separate during rotation relative to each other.

The slat body 308 has at least two distinct portions with different radii of curvature. In the embodiment of FIG. 3, there is a flat/linear portion 310 (radius of curvature of infinity) extending toward hook end 302, and a curved portion 312 that extends toward screw boss 306. The two portions 310/312 could also be reversed, such that the flat/linear portion 310 extends toward screw boss 306 while curved portion 312 extends toward hook end 302. The two portions 310/312 are each shown as roughly half of the slat body 308, but the invention is not so limited, and the transition between different radii of curvature may occur at points other than the midpoint. The curvature of portion 312 of slat 300 may intersect with the approximate center of screw boss 306.

The invention is also not limited to two portions with different radii of curvature, and may have three or more such portions that collectively provide at least two different radii of curvature (e.g., two portions with the same radius of curvature separated by an intermediate portion with a different radius of curvature). Also, at least one of the radii of curvature of portions 310/320 may be greater than the radii of curvature of the outer surface of the reel tube 500.

By virtue of the particular shape of slat body 308 adjacent the hook end 302, the end of slat body 308 does not extend as far inward as that shown in prior art slat 100. As such, main slat 300 can avoid bend 110 as found in slat 100, and the outwardly facing side of hook end 102 is continuous with an extends along the radius of curvature of portion 310. Due to the larger radius of curvature of at least portion 310, portion 310 of slat body 308 is shorter than a comparably dimensioned slat 100 of the prior art, and thus requires less material to fabricate. Similarly, the omission of the bend 110 reduces/eliminates the need for corresponding material. By virtue of this design, if extreme stress is applied to pull apart adjacent slats (e.g., if some started hanging on the curtain 202), slat 100 would have to bear that stress at the bend 110, whereas slat 300 would distribute that stress.

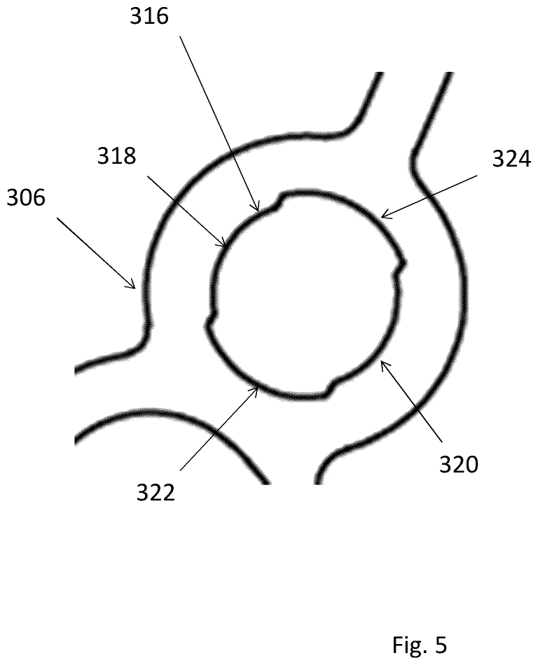

Referring now to FIG. 5, a close up of screw boss 306 is shown. Screw boss 306 is shaped to receive screws or similar attachment components as known in the art to fit within adjacent guide rails. Screw boss 306 may be closed hollow pathway along its length (“closed screw boss”). A closed screw boss 306 does not provide access for water and debris to enter along its length as compared with the open screw boss 106 of prior art slat 100. However, the invention is not limited to a closed screw boss 306, as the screw boss 306 may be partially or completely open along its length.

Inner wall 316 of screw boss 306 may have a non-circular shape, which when present in a closed screw boss can provide the mechanical tolerance to receive mounting screws as discussed above. A non-limiting example of such a shape is that the inner wall 316 of screw boss 306 has different curved sections with different radii. For example, the inner wall 316 of screw boss 306 in FIG. 5 has two opposing curved sections 318 and 320 with a first radius, and two opposing curved sections 322 and 324 with a second larger radius.

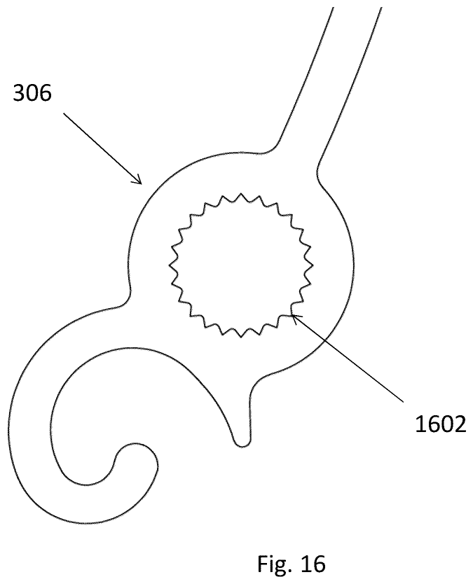

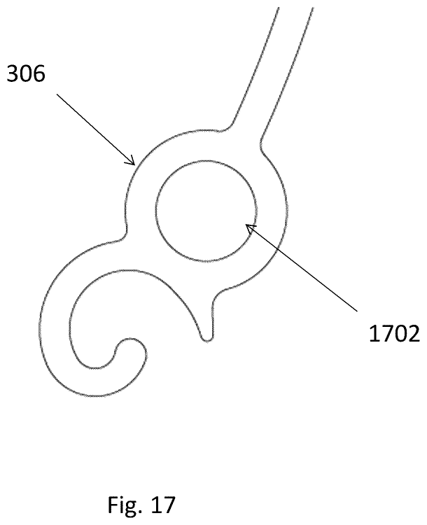

However, the invention is not so limited, and other shapes of screw boss 306 may be used. By way of non-limiting example, FIG. 16 shows screw boss 306 within a serrated interior 1602, and FIG. 17 shows a screw boss 306 with a uniform circular interior shape 1702.

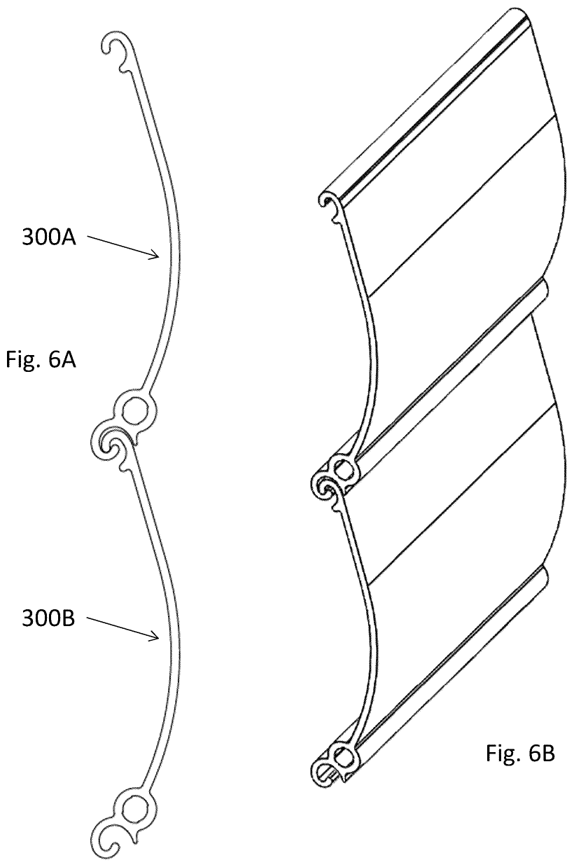

Referring now to FIG. 6, two adjacent main slats 300A and B of a curtain 202 are shown. The hook end 302 of main slat 300B engages the receiving end of main slat 300A to form a hinge. The hinge may be loose and provide a degree of play to allow main slats 300A and 300B to easily rotate relative to each other. In the orientation of FIG. 6A, slat 300B could rotate counterclockwise by about 15 degrees before the back of hook end 302 firmly abuts with the interior of receiving end 304, and about 30 degrees clockwise before the back side of receiving end 304 firmly abuts with the interior of hook end 302 and nub 314. However, the invention is not limited to any particular range of motion.

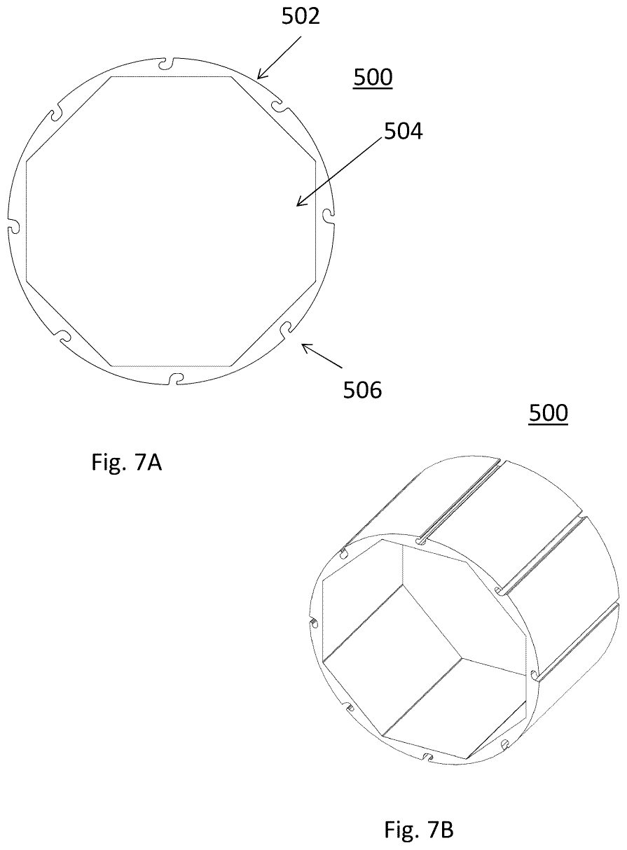

Referring now to FIGS. 7A and B, reel tube 500 is shown. Reel tube 500 may have a circular outer surface 502 and a hollow non-circular inner cavity 504. A drive shaft of matching shape can be inserted into non-circular inner cavity 504 and driven by a motor, crank, spring, or the like to rotate reel tube 500 and any connected curtain 202 to wind and unwind the curtain 202 as discussed above. Cavity 504 is shown as an octagon, but the invention is not so limited and any shape may be used as appropriate. The invention is also not limited to any specific methodology for inducing rotation of reel tube 500.

Recesses 506 extend along the length of reel tube 500, for which as discussed below hook end 402 of starter slat 400 can be inserted. A recess 506 is shown at the center of each side of the octagon as the attachment point of greatest strength, but the invention is not so limited and any number of recesses 506 could be used, and at other locations.

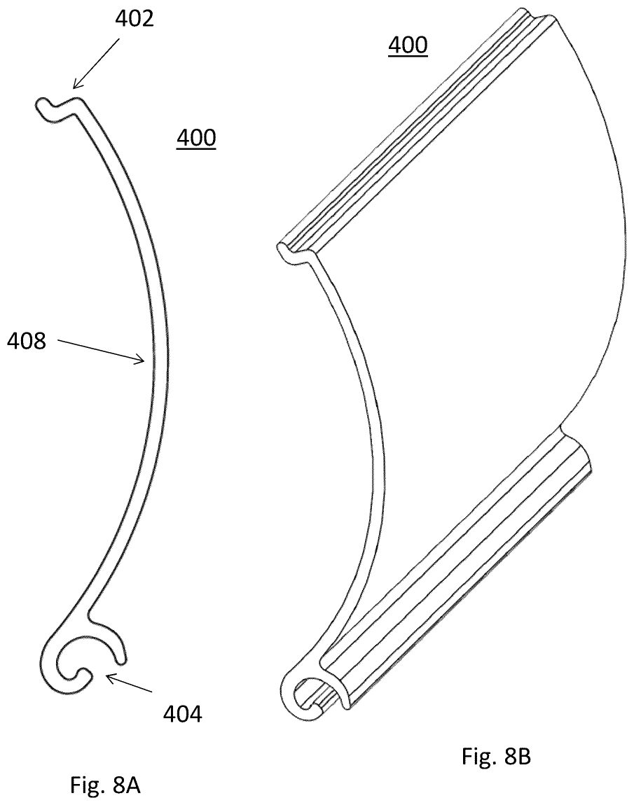

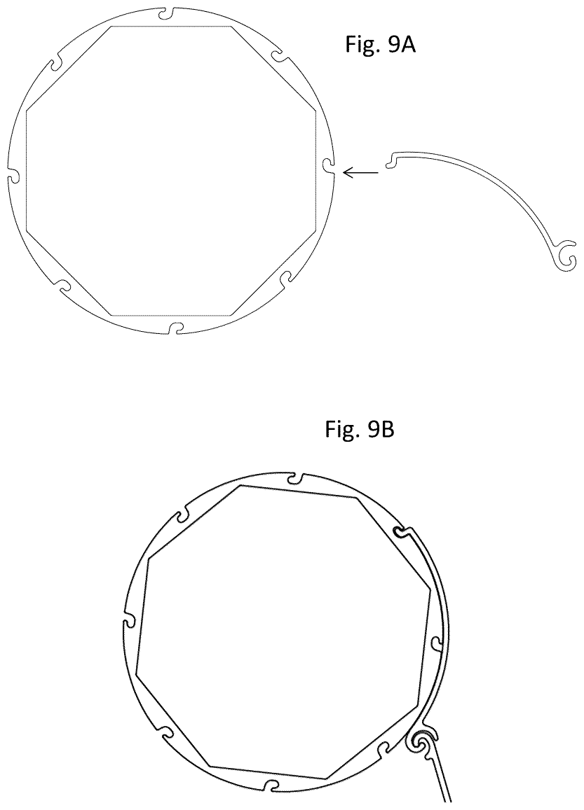

Referring now to FIGS. 8A and 8B, starter slat 400 is shown. Starter slat includes a hook end 402 and a receiving end 404. Hook end 402 is shaped to engage with a recess 506 of reel tube 500 to form a hinge, by sliding lateral insertion or direct insertion in the front; unlike main slat 300, the hinge does not prevent hook end 402 of starter slat 400 from rotationally disengaging with reel tube 500, and it is this feature that allows starter slat 400 to directly insert from the front as shown in FIGS. 9A and 9B. However, the invention is not so limited, and recess 506 could be shaped to only allow for linear engagement and preventing rotational disengagement.

Receiving end 404 may be identical to receiving end 304 of main slat 300 such that it connects with hook end 302 of the first main slat 300 of curtain 202. In this manner, starter slat 400 is an interface between curtain 202 and reel tube 500. However, the invention is not so limited to identical shapes, as any shapes that mates appropriately may be used.

As is known in the art, any particular rolling shutter system includes some driver that rotates curtain 202 in at least one direction. Non-limiting examples of a driver include an electric motor, a hand crank, or a loaded spring. However, the invention is not so limited, and other drivers could be used.

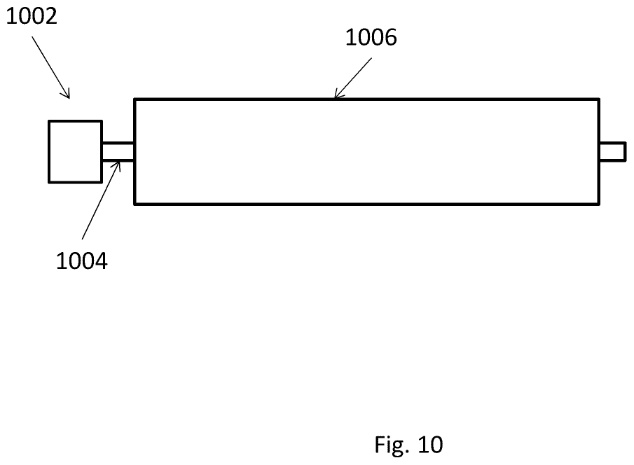

Referring now to FIG. 10, an embodiment of a motorized rolling shutter system is shown. A motor 1002 has a rotating shaft 1004 extending therefrom, and a drive shaft 1006 mounted on the rotating shaft 1004. Rotating shaft 1004 has a shape that engages with cavity 504 to rotate reel tube 500. Appropriate power supply and control electronics (not shown) control motor 1002 to place the shutter system 200 in a retracted state, deployed state, or partially deployed state.

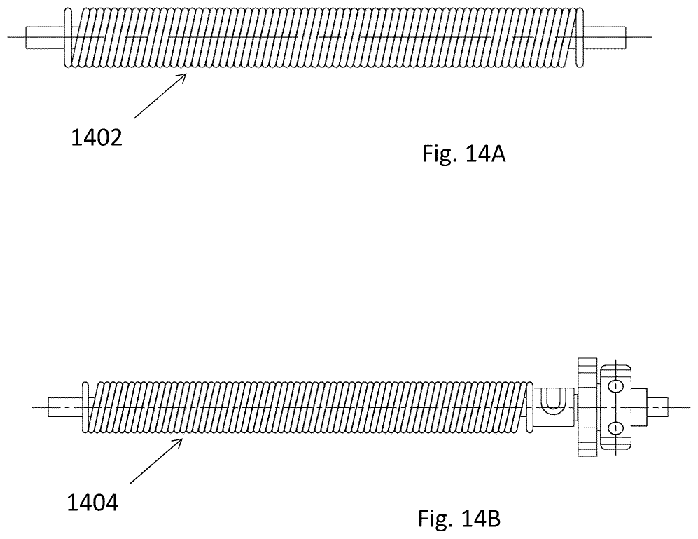

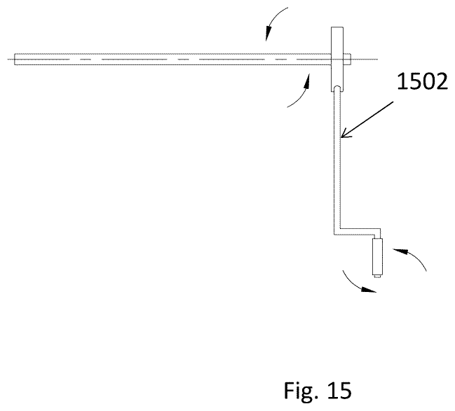

Referring now to FIG. 14A, an embodiment of a loaded spring driver 1402 is shown. FIG. 14B, an embodiment of a loaded spring tensioner driver 1402 is shown. Referring now to FIG. 15, an embodiment of a hand crank 1502 driver is shown. Details of these drivers and their cooperation with drive shafts to drive reel tube 500 is well known in the art and not further described herein.

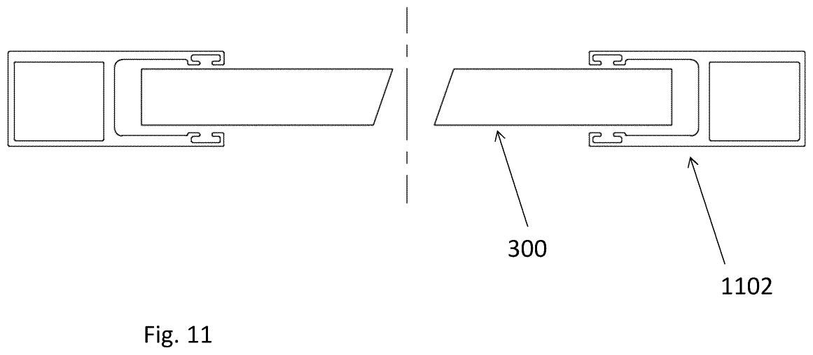

Referring now to FIG. 11, an embodiment of an attachment portion of a rolling shutter system is shown. Guide rails 1102 are mounted over the portal which shutter system 200 is to cover. Each main slat 300 has an end portion that slides within recess of guide rails 1102 to guide the deployment/retraction path of curtain 202 while preventing lateral disengagement of slats 300 of curtain 202.

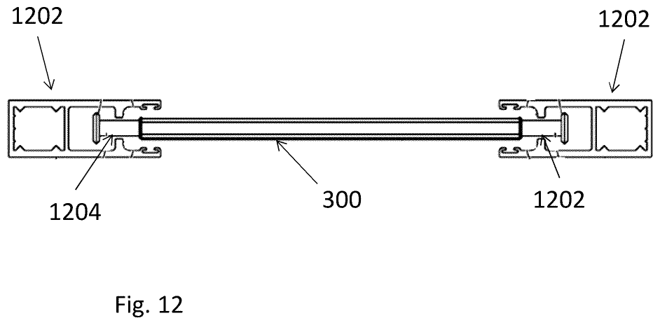

Referring now to FIG. 12, another embodiment of an attachment portion of a rolling shutter system is shown. Screws 1204 as inserted into screw bosses 306 of slats 300 extend into a pair of guide rails 1202. Guide rails 1202 are mounted over the portal which shutter system 200 is to cover. Guide rails 1202 guide the deployment/retraction path of curtain 202 while preventing lateral disengagement of slats 300 of curtain 202.

The shapes of guide rails 1102 and 1202 are exemplary only, and the invention is not limited thereto.

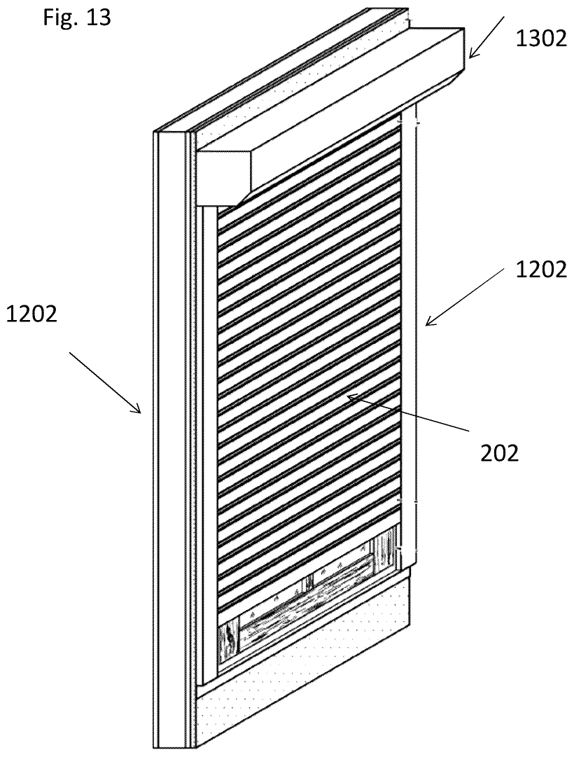

Referring now to FIG. 13, an embodiment of an installed rolling shutter system 200 is shown. A housing 1302 may cover at least reel tube 500 and any drive components. Curtain 202 as shown in a partially deployed state extends between a pair of guide rails 1202.

Main slats 300, starter slat 400 and guide rails 1202 are preferably made from extruded aluminum, although the invention is not so limited.

The various components may be sold collectively as a kit for installation.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A main slat for a roller shutter system, comprising:
a slat body having a first end and a second end;
a hook end connected to the first end of the slat body;
a screw boss connected to the second end of the slat body;
a receiving end connected to the screw boss;
the hook end and the receiving end each being shaped such that the hook end is laterally insertable into the receiving end of an adjacent main slat and when so inserted forms a hinge; and
the slat body having a first end to second end cross section along a central axis of the stat body, the cross section including at least a first portion and a second portion each having a different radius of curvature.

2. The main slat of claim 1, wherein the first portion has a radius of curvature of infinity such that the first portion is substantially linear.

3. The main slat of claim 2, wherein the first portion of the slat body extends from the hook end to the second portion of the slat body, and the second portion of the slat body extends from the first portion of the slat body to the screw boss.

4. The main slat of claim 1, wherein the first portion of the slat body extends from the hook end to the second portion of the slat body, and the second portion of the slat body extends from the first portion of the slat body to the screw boss.

5. The main slat of claim 1, wherein the screw boss is closed along its length.

6. The main slat of claim 1, wherein screw boss has an inner wall with a non-circular shape.

7. The main slat of claim 1, wherein the screw boss has an inner wall with a circular shape.

8. The main slat of claim 1, wherein the first portion has a radius of curvature of infinity such that the first portion is substantially linear, and the second portion has a finite radius of curvature such that the second portion is curved.

9. A roller shutter system kit, comprising:
a reel tube having a lengthwise recess;
a driver configured to drive the reel tube;
a plurality of identical main slats, each main slat comprising:
a slat body having a first end and a second end;
a hook end connected to the first end of the slat body;
a screw boss connected to the second end of the slat body;
a receiving end connected to the screw boss;
the hook end and the receiving end each being shaped such that the hook end is laterally insertable into the receiving end of an adjacent main slat and when so inserted forms a hinge;
the slat body having a first end to second end cross section along a central axis of the stat body, the cross section including at least a first portion and a second portion each having a different radius of curvature;
a starter slat have a first end and a second end, the first end of the starter slat being shaped to insert into the lengthwise recess within the reel tube, and the second end of the starter slat being shaped laterally engage with a hook end of an adjacent main slat; and
a pair of guide rails shaped to receive at least portions of the main slats.

10. The roller shutter system kit of claim 9, wherein the receiving end of the main slat has the same shape as the second end of the starter slat.

11. The roller shutter system kit of claim 9, wherein the first portion has a radius of curvature of infinity such that the first portion is substantially linear.

12. The roller shutter system kit of claim 11, wherein the first portion of the slat body extends from the hook end to the second portion of the slat body, and the second portion of the slat body extends from the first portion of the slat body to the screw boss.

13. The roller shutter system kit of claim 9, wherein the first portion of the slat body extends from the hook end to the second portion of the slat body, and the second portion of the slat body extends from the first portion of the slat body to the screw boss.

14. The roller shutter system kit of claim 9, wherein the screw boss is closed along its length.

15. The roller shutter system kit of claim 9, wherein screw boss has an inner wall with a non-circular shape.

16. The roller shutter system kit of claim 9 wherein the driver is a motor, a spring and/or a crank.

17. A roller shutter system, comprising:
a reel tube having a lengthwise recess;
a driver configured to drive the reel tube;
a plurality of identical main slats interconnected to form a curtain, each main slat comprising:
a slat body having a first end and a second end;
a hook end connected to the first end of the slat body;
a screw boss connected to the second end of the slat body;
a receiving end connected to the screw boss;
the hook end and the receiving end each being shaped such that the hook end is laterally insertable into the receiving end of an adjacent main slat and when so inserted forms a hinge;
the slat body having a first end to second end cross section along a central axis of the slat body, the cross section including at least a first portion and a second portion each having a different radius of curvature;
a starter slat have a first end and a second end, the first end of the starter slat being shaped to insert into within the reel tube, and the second end of the starter slat being shaped laterally engage with a hook end of an adjacent main slat;
a pair of guide rails receiving at least lateral end portions of the curtain; and
the roller shutter system having (a) a retracted state in which the starter slat and the curtain are wound around the reel tube (b) a deployed state in which at least a portion of the curtain is unwound from the reel tube and extends across a portal.

18. The roller shutter system of claim 17, wherein the receiving end of the main slat has the same shape as the second end of the starter slat.

19. The roller shutter system of claim 17, wherein the first portion has a radius of curvature of infinity such that the first portion is substantially linear.

20. The roller shutter system of claim 19, wherein the first portion of the body extends from the hook end to the second portion of the body, and the second portion of the body extends from the first portion of the body to the screw boss.

21. The roller shutter system of claim 17, wherein the first portion of the body extends from the hook end to the second portion of the body, and the second portion of the body extends from the first portion of the body to the screw boss.

22. The roller shutter system of claim 17, wherein the screw boss is closed along its length.

23. The roller shutter system of claim 17, wherein screw boss has an inner wall with a non-circular shape.

24. The roller shutter system of claim 17 wherein the driver is a motor, a spring and/or a crank.
